(19) United States
(12) Patent Application Publication
(10) Pub. No.: US 2008/0007670 A1
(43) Pub. Date: Jan. 10, 2008

(54) Flat panel display having fixing members

(75) Inventor: Xiang Zhang, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/825,994

(22) Filed: Jul. 9, 2007

(30) Foreign Application Priority Data
Jul. 7, 2006 (TW) 95124918

(51) Int. Cl. G02F 1/1333

(52) U.S. Cl. 349/58

(57) ABSTRACT

An exemplary flat panel display (1) includes a front frame (10), a button board (11), and a chassis (13). The front frame includes a pair of first fixing members (106). The chassis includes a pair of second fixing members (133). The button board is secured to the front frame. The first fixing members and the second fixing members are engaged with each other and thereby cooperatively facilitate securing of the chassis to the front frame such that the chassis is reliably maintained in position relative to the front frame.

### FIELD OF THE INVENTION

The present invention relates to a flat panel display (FPD) that includes complementary fixing members configured to ensure the mechanical integrity of the FPD and thus reliable operation of the FPD.

### GENERAL BACKGROUND

Flat panel displays are commonly used as display devices for compact electronic apparatuses. Referring to FIG. 3, a typical flat panel display 3 includes a front frame 30, a button board 31, a display module 32, a chassis 33, a printed circuit board (PCB) 34, and a back cover 35. The button board 31 includes a plurality of control buttons (not labeled) provided thereat. The chassis 33 defines an opening 332 at a bottom portion thereof. In assembly of the flat panel display 3, the PCB 34 and the display module 32 are engaged to the chassis 33 respectively using a plurality of threaded fasteners such as screws. The front frame 30 and the back cover 35 cooperatively accommodate the button board 31, the display module 32, the chassis 33, and the PCB 34 therein.

In a large-sized flat panel display 3, a distance between the chassis 33 and the front frame 30 is relatively great. That is, a distance between the control buttons of the button board 31 and the PCB 34 secured to the chassis 33 is relatively far. Therefore, the distance between the control buttons and the PCB 34 is liable to widened significantly or reduced significantly when the flat panel display 3 is subjected to vibration or shock during operation or transportation. This may result in the control buttons being unable to physically make contact with the PCB 34, or unwanted contact occurring between the control buttons and the PCB 34. When this happens, the flat panel display 3 may operate inaccurately or unreliably, or may even become inoperable. That is, the performance and dependability of the flat panel display 3 are liable to be impaired.

What is needed, therefore, is a flat panel display that can overcome the above-described deficiencies.

### SUMMARY

In an exemplary embodiment, a flat panel display includes a front frame, a button board, and a chassis. The front frame includes a pair of first fixing members. The chassis includes a pair of second fixing members. The button board is secured to the front frame. The first fixing members and the second fixing members are engaged with each other and thereby cooperatively facilitate securing of the chassis to the front frame such that the chassis is reliably maintained in position relative to the front frame.

Other novel features, advantages and aspects will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of at least one embodiment of the present flat panel display. In the drawings, like reference numerals designate corresponding parts throughout various views, and all the views are schematic.

FIG. 1 is an exploded, isometric view of a flat panel display according to an exemplary embodiment of the present invention, viewed from a rear aspect.

FIG. 2 is an exploded, isometric view of the flat panel display of the exemplary embodiment, viewed from a front aspect.

FIG. 3 is an exploded, isometric view of a conventional flat panel display.

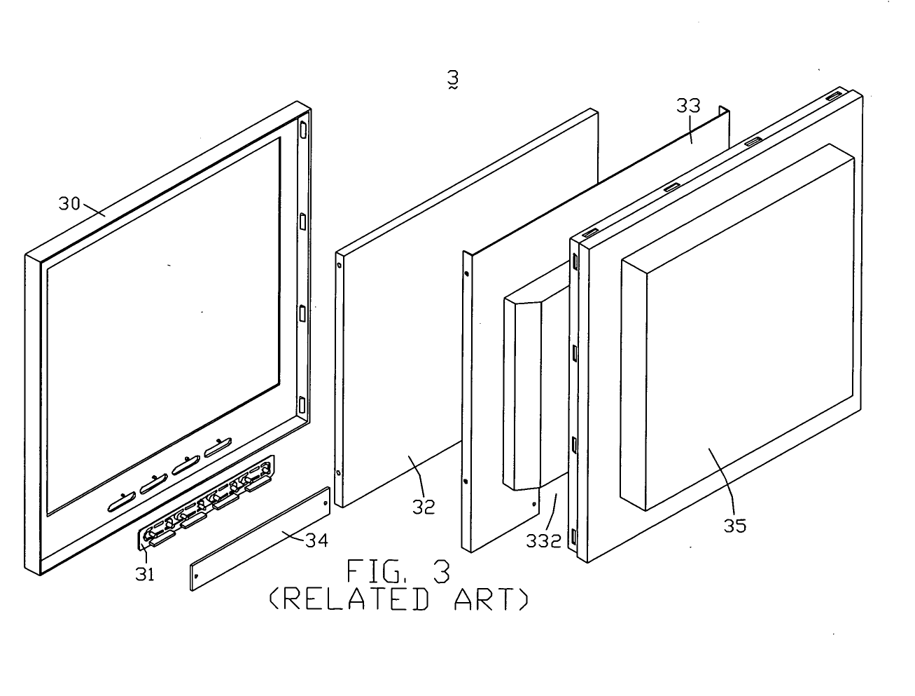

### DETAILED DESCRIPTION OF PREFERRED EMBODIMENTS

Reference will now be made to the drawings to describe preferred and exemplary embodiments in detail.

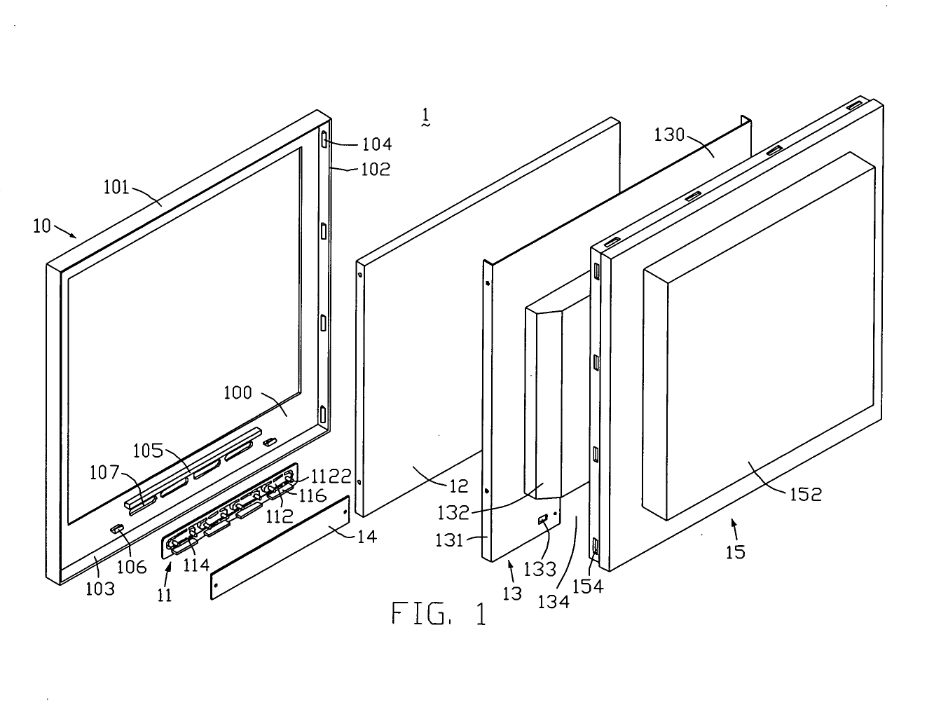

Referring to FIG. 1, a flat panel display 1 according to an exemplary embodiment of the present invention is shown. The flat panel display 1 includes a front frame 10, a button board 11, a display module 12, a chassis 13, a PCB 14, and a back cover 15. The front frame 10 and the back cover 15 cooperatively define a space (not labeled) for accommodating the button board 11, the display module 12, the chassis 13, and the PCB 14.

The front frame 10 includes a faceplate 100, a top peripheral plate 101, two opposite side peripheral plates 102, and a bottom peripheral plate 103. The faceplate 100 is generally frame-shaped, and defines a rectangular window (not labeled) for allowing viewing of the display module 12. The faceplate, the top peripheral plate 101, the side peripheral plates 102, and the bottom peripheral plate 103 extend perpendicularly rearward from respective side edges of the faceplate 100. The front frame 10 further includes a plurality of fixing protrusions 104 extending inwardly from the inner sides of the top peripheral plate 101 and the side peripheral plates 102. The fixing protrusions 104 are spaced a distance from the faceplate 100.

The faceplate 100 includes a supporting rib 105, a pair of first fixing hooks 106, and a plurality of button holes 107. The supporting rib 105 is horizontally oriented at an inner side (not labeled) of the faceplate 100, and is located below the window. A vertical distance between the top peripheral plate 101 and the supporting rib 105 is substantially equal to a height of the display module 12. The button holes 107 are defined below the supporting rib 105. In the illustrated embodiment, the button holes 107 are four elongate through holes defined in the faceplate 100. The first fixing hooks 106 extend inwardly from the inner side of the faceplate 100, and are generally adjacent to two opposite ends of the supporting rib 105 respectively. Each of the first fixing hooks 106 includes an essentially rectangular first base portion (not labeled), and a first fixing block (not labeled) extending upwardly from the first base portion. In the illustrated embodiment, the first base portions of the first fixing hooks 106 are substantially coplanar, and the first fixing blocks of the first fixing hooks 106 are substantially coplanar.

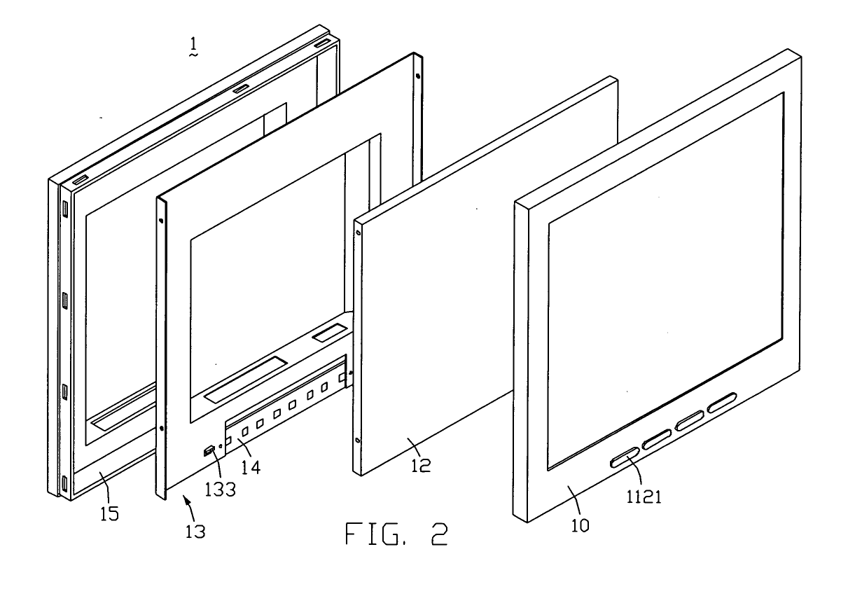

The button board 11 includes a plurality of control buttons 112, a plurality of elastic arms 114 at each control button 112, and a plurality of spacing blocks 116. Referring also to FIG. 2, each control button 112 includes a front pressing end 1121, and a rear conductive terminal 1122 corresponding to the pressing end 1121. The elastic arms 114 interconnect the control button 112 and a main body (not labeled) of the button board 11. That is, the elastic arms 114 allow elastic deformation and recovery of the control buttons 112. The spacing blocks 116 extend perpendicularly rearward from a bottom portion of a main body of the button board 11, and are located below the control buttons 112 in one-to-one correspondence. The spacing blocks 116 have a same thickness, which is substantially equal to a thickness of the supporting rib 105.

The chassis 13 includes a main plate 130, two opposite side walls 131, a first offset back wall 132, a pair of second fixing hooks 133, and an opening 134. The main plate 130 is substantially rectangular. The side walls 131 are essentially narrow flanges, which extend perpendicularly forward from two opposite sides edges (not labeled) of the main plate 130 respectively. A distance between the side walls 131 is substantially equal to a width of the display module 12. The first back wall 132 extends rearward from the main plate 130. Thereby, the first back wall 132 defines a housing (not labeled) rearward of the display module 12 for accommodating other components (not shown) of the flat panel display 1. The second fixing hooks 133 of the chassis 13 respectively correspond to the first fixing hooks 106 of the front frame 10. Each of the second fixing hooks 133 includes an essentially rectangular second base portion (not labeled), and a second fixing block (not labeled) extending down from the second base portion. The second bases of the second fixing hooks 133 are substantially coplanar. The second fixing blocks of the second fixing hooks 133 are coplanar, and respectively correspond to the first fixing blocks of the first fixing hooks 106. The opening 134 is defined at a bottommost end of the main plate 130, and is located between the second fixing hooks 133. The chassis 13 is preferably made from iron, steel, aluminum, magnesium, or a material containing any suitable alloy thereof.

The back cover 15 has a size substantially the same as a size of the front frame 10, and includes a second offset back wall 152 corresponding to the first back wall 132 of the chassis 13. The back cover 15 includes a plurality of notches 154 defined in three peripheral sides (not labeled) thereof. The notches 154 respectively correspond to the fixing protrusions 104 of the front frame 10. The back cover 15 is preferably made from plastic, polymer, or another suitable material.

The flat panel display 1 can be assembled as follows. First, the PCB 14 is secured to the chassis 13 using a plurality of threaded fasteners such as screws (not shown). The PCB 14 is positioned adjacent to the opening 134 of the chassis 13, such that a plurality of electrically conductive contact portions (not labeled) of the PCB 14 are exposed to the front frame 10. Second, the display module 12 is received in the chassis 13, and secured to the chassis 13 using a plurality of threaded fasteners such as screws (not shown). The PCB 14 is mechanically and electrically connected to a bottom of the display module 12, and is located below the display module 12. Third, the button board 11 is secured to the front frame 10. The pressing ends 1121 of the control buttons 112 are extended through the respective button holes 107 of the front frame 10. A topmost extremity of the button board 11 is just below the supporting rib 105, and the spacing blocks 116 are substantially parallel with the supporting rib 105. That is, the control buttons 112 are located between the supporting rib 105 and the spacing blocks 116. Fourth, the chassis 13 is attached to the front frame 10. The second fixing hooks 133 are snappingly engaged with the first fixing hooks 106, thereby firmly securing the chassis 13 to the front frame 10. The display module 12 attached to the chassis 13 is supported by the supporting rib 105 of the front frame 10. Fifth, the back cover 15 is attached to the front frame 10. The fixing protrusions 104 of the front frame 10 are snappingly engaged in the respective notches 154 of the back cover 15. Thereby, the front frame 10 and the back cover 15 are firmly secured together, and cooperatively receive the button board 11, the display module 12, the chassis 13, and the PCB 14 therein. The conductive terminals 1122 of the control buttons 112 respectively correspond to the contact portions of the PCB 14, and are spaced a predetermined distance from the contact portions.

The first fixing hooks 106 and the second fixing hooks 133 cooperate to help firmly engage the chassis 13 to the front frame 10. Therefore, the distance between the control buttons 112 and the contact portions of the PCB 14 can be reliably maintained, even when the flat panel display 1 is subjected to vibration or shock during operation or transportation. Thus the flat panel display 1 can be accurately and reliably operated, and the performance and dependability of the flat panel display 1 are enhanced.

Further or alternative embodiments may include the following. In one example, the front frame 10 can have one, three or more first fixing hooks 106, and the chassis 13 can have a corresponding number of second fixing hooks 133.

It is believed that the present embodiments and their advantages will be understood from the foregoing description, and it will be apparent that various changes may be made thereto without departing from the spirit or scope of the invention or sacrificing all of its material advantages, the examples hereinbefore described merely being preferred or exemplary embodiments of the invention.

What is claimed is:

1. A flat panel display comprising:
a front frame comprising at least one first fixing member;
a button board secured to the front frame; and
a chassis comprising at least one second fixing member, wherein the at least one first fixing member and the at least one second fixing member are engaged with each other and thereby cooperatively facilitate securing of the chassis to the front frame such that the chassis is reliably maintained in position relative to the front frame.

2. The flat panel display as claimed in claim 1, wherein the at least one first fixing member is adjacent to the button board.

3. The flat panel display as claimed in claim 1, wherein the at least one first fixing member comprises a first base portion extending from the front frame, and a fixing block extending from the first base portion in a first direction.

4. The flat panel display as claimed in claim 3, wherein the at least one second fixing member comprises a second base portion extending from the chassis, and a second fixing block extending from the second base portion in a second direction opposite to the first direction.

5. The flat panel display as claimed in claim 4, the first fixing block and the second fixing block are snappingly engaged with each other and thereby cooperatively secure the chassis to the front frame.

6. The flat panel display as claimed in claim 1, further comprising a printed circuit board secured in a fixed position relative to the chassis.

7. The flat panel display as claimed in claim 5, wherein the printed circuit board is adjacent to the at least one second fixing member.

8. The flat panel display as claimed in claim 1, wherein the button board comprises a plurality of buttons provided thereat.

9. The flat panel display as claimed in claim 8, wherein the front frame comprises a plurality of button holes respectively receiving the buttons of the button board therethrough.

10. The flat panel display as claimed in claim 8, wherein each button comprises an external pressing end and an internal conductive terminal corresponding to the pressing end.

11. The flat panel display as claimed in claim 10, wherein the printed circuit board comprises a plurality of electrically conductive contact portions respectively corresponding to the conductive terminals of the buttons of the button board.

12. The flat panel display as claimed in claim 6, wherein the front frame further comprises a supporting rib located above the button board.

13. The flat panel display as claimed in claim 12, wherein the button board comprises a plurality of spacing blocks extending from a main body thereof in a direction toward the chassis.

14. The flat panel display as claimed in claim 12, further comprising a display module received in and secured to the chassis, wherein the circuit board is secured to the display module and thereby secured in the fixed position relative to the chassis.

15. The flat panel display as claimed in claim 14, wherein the display module is supported by the supporting rib.

16. A flat panel display comprising:
a front frame comprising at least one first fixing member;
a chassis comprising at least one second fixing member;
a display module secured to the chassis;
a printed circuit board secured to the display module, the printed circuit board comprising a plurality of contact portions; and
a button board secured to the front frame, the button board comprising a plurality of buttons corresponding to the contact portions of the printed circuit board;
wherein the at least one first fixing member and the at least one second fixing member are engaged with each other and thereby cooperatively facilitate securing of the chassis to the front frame such that a predetermined constant gap is maintained between the buttons of the button board and the contact portions of the printed circuit board when the buttons are not in use.

17. The flat panel display as claimed in claim 16, wherein the at least one first fixing member is adjacent to the button board.

18. The flat panel display as claimed in claim 16, wherein the at least one first fixing member comprises a first base portion extending from the front frame, and a fixing block extending from the first base portion in a first direction.

19. The flat panel display as claimed in claim 18, wherein the at least one second fixing member comprises a second base portion extending from the chassis, and a second fixing block extending from the second base portion in a second direction opposite to the first direction.

20. The flat panel display as claimed in claim 19, the at least one first fixing block and the at least one second fixing block are snappingly engaged with each other, thereby cooperatively securing the chassis to the front frame such that the predetermined constant gap is maintained.
